(19) United States
(12) Patent Application Publication
(10) Pub. No.: US 2006/0265338 A1
(43) Pub. Date: Nov. 23, 2006

(54) System and method for usage based key management rebinding using logical partitions

(76) Inventors: Matt F. Rutkowski, Pflugerville, TX (US); Thomas A. Bellwood, Austin, TX (US); Robert B.t. Chumbley, Austin, TX (US); Alexander H. Tarpinian, Austin, TX (US)

Correspondence Address: JANIS E. CLEMENTS, 3112 LOMITA DRIVE, AUSTIN, TX, 78738, US

(21) Appl. No.: 11/130,726

(22) Filed: May 17, 2005

(51) Int. Cl. H04L 9/00

(52) U.S. Cl. 705/71

(57) ABSTRACT

A system and method for usage based key management rebinding using logical partitions that intelligently organizes the scheduling and re-encryption processing of title keys into logical groups. Candidate title keys of the present invention are sorted into logical groups based upon content meta-data. This meta-data can be based upon content classification, usage patterns, frequency of use, currency of access and other configurable parameters. Title keys are partitioned based on meta-data and priority can be established between partitions. Title keys are re-encrypted with current binding information based on partition priority. Said title keys are tracked to ensure they are re-encrypted.

### CROSS-REFERENCE

Copending application (Attorney Docket No. AUS920050247US1), Ser. No. ______, Rutkowski et al, assigned to common assignee, filed ______. This reference is hereby incorporated by reference.

### TECHNICAL FIELD

The present invention relates to data encryption, and particularly to usage based key management rebinding using logical partitions.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is Internet related distribution of documents. The Web or Internet, which had quietly existed for over a generation as a loose academic and government data distribution facility, reached, “critical mass” and commenced a period of phenomenal expansion. With this expansion, businesses and consumers have direct access to all matter of documents and media through the Internet.

With the advent of consumer digital technology, content such as music and movies are no longer bound to the physical media that carry them. Advances in consumer digital technology present new challenges to content owners such as record labels, studios, distribution networks, and artists who want to protect their intellectual property from unauthorized reproduction and distribution. Recent advances in broadcast encryption offer an efficient alternative to more traditional content protection solutions based on public key cryptography. In comparison with public key methods, broadcast encryption requires orders of magnitude less computational overhead in compliant devices. Compliant devices are those which follow the key management protocol defined to govern the behavior of devices participating in a particular content protection system, and which have not been altered or used in attacks designed to compromise that system. In addition, broadcast encryption protocols are one-way, not requiring any low-level handshakes, which tend to weaken the security of copy protection schemes. However, by eliminating two-way communications, the potentially expensive return channel on a receiver may be eliminated, lowering overhead costs for device manufacturers and users.

IBM has developed a content protection system based on broadcast encryption called eXtensible Content Protection, referred to as “xCP.” xCP supports a trusted domain called a ‘cluster’ that groups together a number of compliant devices. Content can freely move among these devices, but it is useless to devices that are outside the cluster. Other examples of broadcast encryption applications include Content Protection for Recordable Media (CPRM) media, Content Protection for Pre-Recorded Media (CPPM) media, and Advanced Access Content System (AACS) next-generation media.

Broadcast encryption schemes bind a piece of content to a particular entity, such as a piece of media (e.g. a compact disk or DVD), a server, a group of authorized devices, or a user. Broadcast encryption binds the content by using a media key block (MKB), also known as a key management block (KMB) or session key block) that allows compliant devices to calculate a cryptographic key (the media or management key) using their internal device keys while preventing circumvention (non-compliant) devices from doing the same. One example of a binding scheme is binding to a specific receiver in standard PKI applications wherein content is encrypted with a session key, which is then encrypted with a receiver's public key. The content can only be retrieved with the receiver's private key. Another example of a binding scheme is binding to a specific media in CPRM and AACS Media wherein content is encrypted with a title key, which is then encrypted with a key resulting from a one-way function of a media identifier and a media key (calculated from the media key block described above). A third example of a binding scheme is binding to a specific group of devices in a user's domain, as in xCP Cluster Protocol, wherein content is encrypted with a title key, which is then encrypted with a key resulting from a one-way function of the user's cluster authorization table and binding ID and the user's current management key (calculated from the user's current key management block). Note, when used in association with the Cluster Protocol described herein, we will refer to the associated key management structure as a key management block (KMB), to acknowledge the protocol's broader applicability beyond media.

Broadcast encryption does not require authentication of a device and can be implemented with symmetric key encryption, allowing it to be much more efficient than public key cryptography. After calculating a media key by processing the key management block (KMB), the scheme uses the media key to bind the content to an entity with a binding identifier, resulting in the binding key. An indirection step occurs when a title key is then chosen and encrypted or decrypted with the binding key, resulting in an encrypted title key or an encrypted indirect key. The content itself may then be encrypted with the title key and the encrypted content may be stored with the encrypted title key. A compliant device that receives the encrypted content and the encrypted title key may use the same KMB and the binding identifier to decrypt the encrypted title key and then to use that title key to decrypt the content. The compliant device first must reproduce the binding key using the KMB, the binding identifier and its device keys, and then decrypt the title key from the encrypted title key using the binding key. Once the compliant device has the title key, it may decrypt the content itself. A circumvention device will not have device keys needed to process the KMB and thus will not be able to reproduce the binding key or be able to decrypt the content. Also, if the content has been copied to a different entity with a different identifier by a non-compliant device, the compliant device with valid device keys will not be able to calculate the correct binding key because the binding identifier associated with the new entity is different than the original one.

Under prior art systems, all content would be encrypted with a title key which would itself be encrypted with the binding key. Content items are referenced and decoded using title keys. Said content items are owned by a single participant in this key management binding scheme, which is responsible for the re-encryption of said title keys when indirections change that result in a new binding key. For example, the introduction of a new device into an existing network cluster causes an update to an authorization table, i.e. an indirection mechanism on the binding key. Ideally, implementations using broadcast encryption perform a re-encryption procedure on all title keys affected by the binding change. This is necessary in order to insure that all content present on devices within the network cluster remains bound to the new definition of that network cluster. Optimally, re-encryption of said title keys occurs in a timely manner so as not to delay a user's access to associated content. Implementations typically attempt to re-encrypt affected title keys immediately, or without regard to use patterns. If the number of content items affected is large, as can often be the case for devices with entertainment content, the operation is time consuming and causes delay to the user.

The present invention is directed to solving this problem by providing a means for intelligently organizing the scheduling and re-encryption processing of title keys into logical groups based upon how frequently and/or how recently each content item has been accessed. The candidate title keys are sorted into these logical groups based upon usage patterns and other configurable parameters. The intelligent organization and scheduling behavior is achieved through the introduction of associated meta-data that describes usage and user preferences, such as usage pattern oriented and user preference oriented. With usage patterns, meta-data can include content last accessed within some defined period of time, most frequently played content within some user defined metric or a policy based default, or the like. With user preference, meta-data can include content classification, usage preference, recently acquired content, or the like.

Therefore, there is a need for an effective and efficient system of encrypting and decrypting content on a cryptographic system, and particularly for the secure and convenient handling of cryptographic binding state information.

### SUMMARY OF THE PRESENT INVENTION

The present invention provides a solution to the previously recited problems by a system, method and related computer program for usage and/or preference based key management rebinding using logical partitions. More particularly, the present invention provides a means for associating title keys with binding information for encrypting the title keys of a device, which comprises grouping title keys for processing, organizing scheduling and re-encryption processing of title keys into groups based on access frequency of each content item, sorting candidate title keys into the groups based on usage patterns, and introducing preferences based on associated meta-data describing content. The usage pattern can be based on content last accessed within a defined period of time, on most frequently played content, on user preference, or the like. User preference could include content classification, recently acquired content, or the like. A device used in the present invention could execute an application or render one or more digital formats (including but not limited to audio and/or video), such as an MP3 or DVD player, or some similar device.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a line drawing of an exemplary network architecture in which methods and systems according to embodiments of the present invention may be implemented;

FIG. 2 is a generalized view of a system that may be used in the practice of the present invention;

FIG. 3 is an illustrative flowchart describing setting up of the functions for usage based and user preference based key management rebinding using logical partitions of the present invention;

FIG. 4 is a flowchart of an illustrative run of the program related to rebinding change set up according to FIG. 3; and

FIG. 5 is a flowchart of an illustrative run of the program related to accessing a title set up according to FIG. 3.

### DETAILED DESCRIPTION OF THE PREFERRED EMBODIMENT

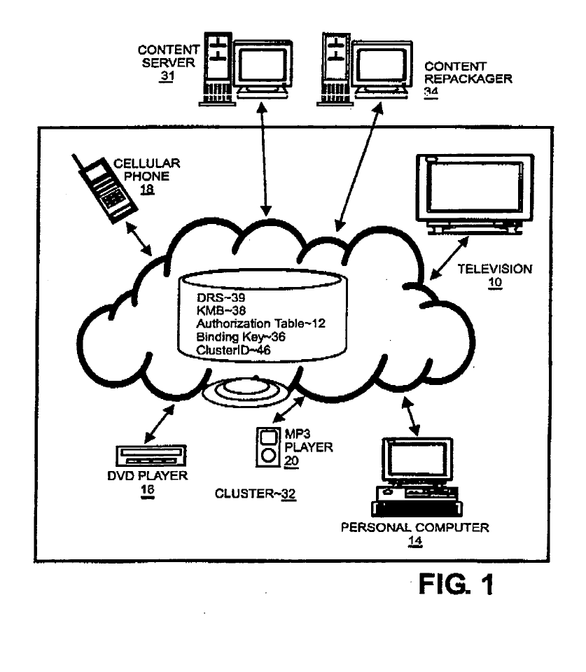

Referring to FIG. 1, a line drawing of an exemplary network architecture is shown in which methods and systems according to embodiments of the present invention may be implemented. While the present invention is operable with various binding schemes, such as binding to a specific receiver in standard PKI applications, binding to a specific media in CPRM and AACS Media, FIG. 1 shows the binding scheme wherein the binding is to a specific user's content in xCP Cluster Protocol. The network of FIG. 1 includes an xCP compliant network cluster 32 that includes several xCP compliant network devices including a cellular telephone 18, a television 10, a DVD player 16, a personal computer 14, and an MP3 player 20. The network may be any type of wired or wireless network, such as Local Area Network (LANS) or Wide Area Networks (WANS). Content may be any data deliverable from a source to a recipient and may be in the form of files such as an audio data file, a video data file, a media data file, a streaming media file, an application file, a text file, document or a graphic. An encryption system allows receiving devices within the home network to freely share and utilize encrypted content between them while preventing non-compliant devices from decrypting the encrypted content. A receiving device may optionally be able to record content onto a recorded device for use outside the home network.

The network cluster supports a key management block 38 for the cluster, an authorization table 12 that identifies all the devices currently authorized to join in the cluster, a binding key 36 for the cluster, and a cluster ID 46. The key management block 38 is a data structure containing an encryption of a management key with every compliant device key. That is, the key management block contains a multiplicity of encrypted instances of a management key, one for every device key in the set of device keys for a device. The binding key 36 for the cluster is calculated as a cryptographic one-way function of a management key and a cryptographic hash of a cluster ID and a unique data token for the cluster. The management key for the cluster is calculated from the key management block 38 and device keys.

The network of FIG. 1 includes a content server 31 that is capable of encrypting content with title keys provided to it by content providers, content owners, or a legal licensing authority. Content server 31 is also capable of calculating a binding key for a cluster, given enough information about the cluster, and using the binding key 36 to encrypt a title key and package it with encrypted contents. More particularly, content server 31 may control broadcast encryption of content for a network cluster 32 from outside the cluster by receiving from a network device in the cluster a key management block 38 for the cluster 32, a unique data token for the cluster 32, and an encrypted cluster ID. The content server is capable of using the key management block 38 for the cluster 32, the unique data token for the cluster 32, and the encrypted cluster ID to calculate the binding key for the cluster.

The network of FIG. 1, while not shown, can include an optional digital rights server that is capable of storing rights objects that define rights for using Digital Rights Management (DRM) protected content. Such a configuration may optionally be used as a source of content for introduction into the broadcast encryption based content protection system. Such a system could work in conjunction with the xCP cluster to calculate a binding key and use it to encrypt a title key, which the DRM system could maintain in a rights object. More particularly, if a third party solution exists, the present invention is compatible with said third party solution. The solution can act as a source of content for the present invention. If a solution is present, access is granted or denied based upon unique identification of the requesting device. A device capable of interacting with the source of content for introduction into the broadcast encryption based content protection system may be capable of preparing and repackaging protected content for use in the broadcast encryption based system. This device may either be a part of cluster 32, or otherwise have the information necessary to perform the aforementioned repackaging steps by using a key management block 38 for the cluster 32, a unique data token for the cluster 32, and an encrypted cluster ID to calculate a binding key for the cluster, and encrypting a title key with a binding key 36. At this point, an external check could be made to the third party solution prior to making content available to a device participating in cluster 32. If the server permits the repackaging and movement of content from its trust domain into the broadcast encryption based content protection system of cluster 32, then the encrypted content encrypted title key and content usage conditions are provided to the requesting device in cluster 32.

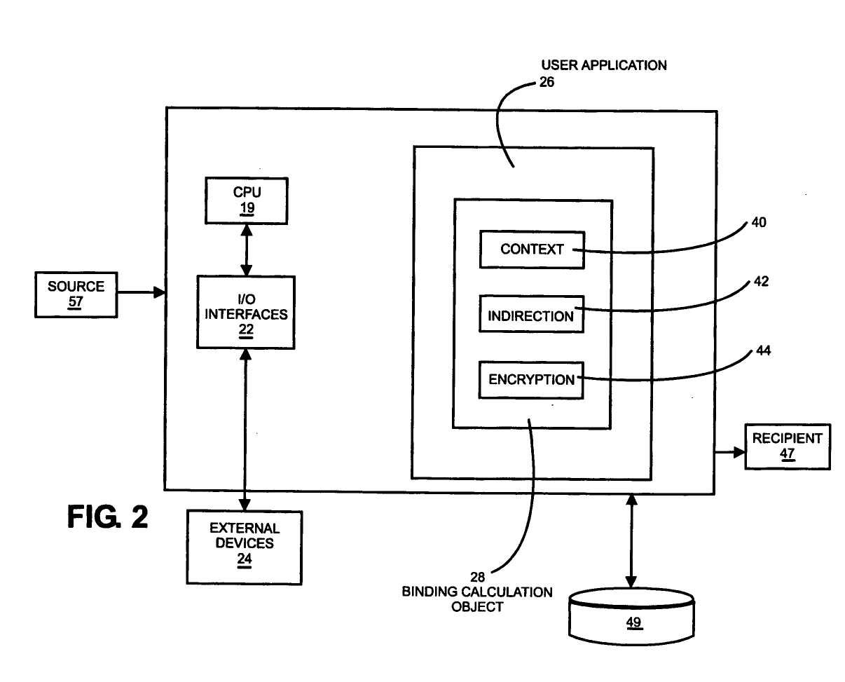

A generalized diagram of a cryptographic system that may be used in the practice of the present invention is shown in FIG. 2. The cryptographic system may be any combination of hardware and/or software that may perform one or more of such tasks as encrypting or decrypting, and attaching a key to content. A typical cryptographic system may be a general purpose computer with a computer program that, when loaded and executed, carries out the methods described herein. Alternatively, the cryptographic system may be a specific use computer system containing specialized hardware for carrying out one or more of the functional tasks of the cryptographic system. A specific use computer system may be part of a receiving device, for example, such as an encryption/decryption module associated with a DVD player. Cryptographic system may include one or more central processing units (CPUs 19), an input/output (I/O) interface 22, a user application 26 that includes a binding calculation object 28 wherein a context key 40, indirection key(s) 42, and encryption key 44 are found, external devices 24, and a database 49.

Cryptographic system may also be in communication with a source 57 or a recipient 47. Source 57 may be the source of any content to be encrypted or decrypted or any entity capable of sending transmissions, such as a content owner, a content service provider, or a receiver in a home network. Information received from a source 57 may include any type of information, such as encrypted content, content, content usage conditions, a KMB, encrypted title keys, or binding identifiers. Similarly, a recipient 47 may be any entity capable of receiving transmissions or that is a destination for any encrypted content or other information, such as a receiver in a home network.

CPU 19 may include a single processing unit or may be distributed across one or more processing units in one or more locations, such as on a client and server or a multi-processor system. I/O interface 22 may include any system for exchanging information with an external source. External devices 24 may include any known type of external device, such as speakers, a video display, a keyboard to other user input device, or a printer. Database 49 may provide storage for information used to facilitate performance of the disclosed embodiment. Database 49 may include one or more storage devices, such as a magnetic disk drive or optional disk drive.

User application 26 may include components of application specific information, such as media ID, or authorization table. Binding calculation object 28 may include a context key 40 that is set up via a user's specific information, one or more indirection keys 42, and a final encryption key 44 used to encrypt content. The binding calculation object 28 can be reused in several various applications and is a standard defined mechanism. This standard defined mechanism can be used to create trusted entities that handle a state of a binding transaction for an application. Secret information, such as title keys, media keys, or session keys, can be kept inside these trusted entities (binding calculation objects) decreasing the security risks of transmitting sensitive information in application components. Specific measures can be taken to detect and prevent decryption of title keys outside of the trusted entities.

The binding calculation object or trusted cryptography object 28 can be implemented as a trusted software component that executes in a trusted operating system environment. For example, a computer system could be supplied with a trusted Java Virtual Machine (Java is a trademark of Sun Microsystems, Inc.) or other virtual machine embodiment whose execution options are known and controlled by the system owner. In the alternative, binding calculation object 28 can be embodied in a read only memory device or application specific hardware device to ensure that no compromising operations can be performed. The advantage is that the decrypted secret information such as the title key is always maintained in the binding object 28 with external access blocked and thus cannot be compromised.

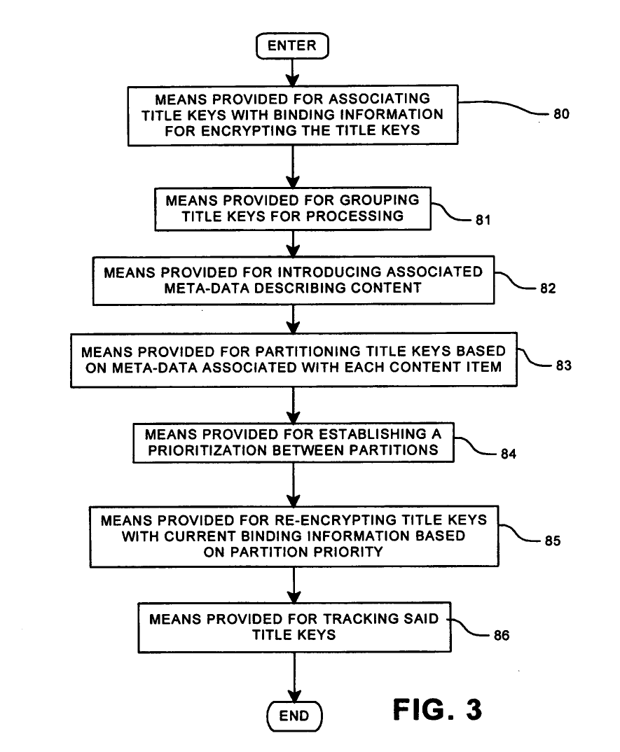

FIG. 3 is a flowchart showing the development of a process according to the present invention for usage based key management rebinding using logical partitions. Means are provided for associating title keys with binding information for encrypting the title keys with content accessible to authorized devices, step 80. Means are provided for grouping title keys for processing, step 81. Means are provided for introducing associated meta-data describing content, step 82. Elements of the meta-data can be based upon usage patterns of the content established over a defined period of time. Usage patterns can be based on such criteria as content last accessed within a defined period of time, most frequently played content, user preference, or the like. User preference can be based on such criteria as content classification, recently acquired content, or the like. Means are provided for partitioning title keys based on meta-data associated with each content item, step 83. Means are provided establishing a prioritization between partitions, step 84. Means are provided for re-encrypting title keys with current binding information based on partition priority, step 85. Lastly, means are provided for tracking said title keys to ensure they are re-encrypted, step 86.

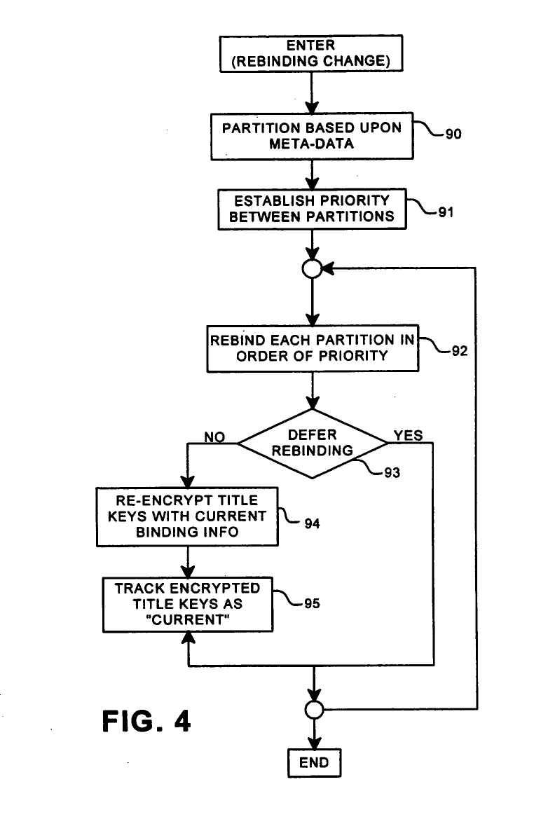

A simplified run of the process set up in FIG. 3 will now be described with respect to the flowchart of FIG. 4 in relation to the rebinding change of the present invention. First, title keys of a device which contain binding information are partitioned based on meta-data associated with each content item previously introduced into the meta-data, step 90. Meta-data associated with content items can include many things, such as usage based information, a record of most recently acquired content, most frequently used items, user-defined preferences, or the like. Meta-data can be used separately or in combination with other meta-data to establish criteria for organizing encrypted title keys corresponding to content items into various prioritized partitions for re-encryption after a binding change. The device can be one that plays one or more digital formats, such as an MP3 or video player, or some other similar device. Priority is established between partitions, step 91. Partitioning of encrypted title keys could take place as a reaction to a rebinding operation, or independently in an off-line manner, based upon criteria established by the user. Rebinding begins for each partition in order of priority, step 92. A determination is made as to whether to defer rebinding, step 93. If Yes, the process returns to step 92 wherein the rebinding process can begin for each partition in order of priority, or the process can end. If No the title keys are re-encrypted with current binding information, step 94. The encrypted title keys are then tracked as “current”, step 95. Then the process can return to step 92 for further rebinding, or the process can end.

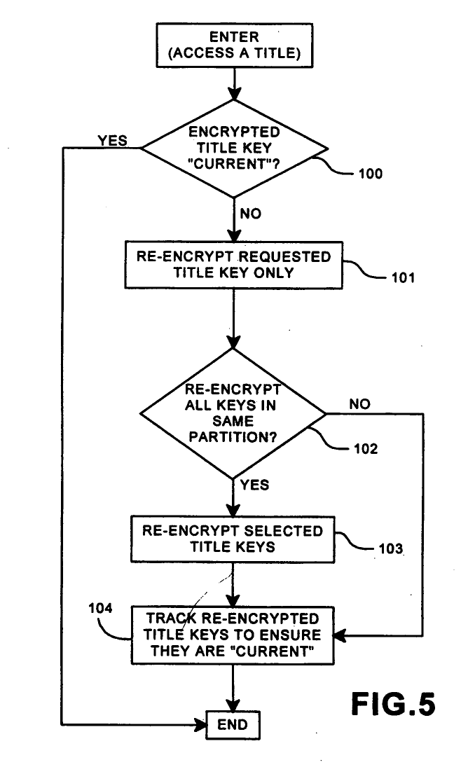

A simplified run of the process set up in FIG. 3 will now be described with respect to the flowchart of FIG. 5 in relation to the accessing of a title of the present invention. First, a determination is made as to whether the encrypted title key is “current”, step 100. If Yes, the process ends. If No, only the requested title key is re-encrypted, step 101. Then a determination is made as to whether to re-encrypt all keys in the same partition, step 102. If Yes, selected title keys are re-encrypted, step 103. The re-encrypted title keys are then tracked to ensure they are “current”, step 104, and the process ends. If No, the process proceeds to the tracking process of step 104, after which the process ends.

The present invention is described in this specification in terms of methods for the secure and convenient handling of cryptographic binding state information. One skilled in the art should appreciate that the processes controlling the present invention are capable of being distributed in the form of computer readable media of a variety of forms. The invention may also be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having a suitable programming means will be capable of executing the steps of the method of the invention as embodied in a program product. Although certain preferred embodiments have been shown and described, it will be understood that many changes and modifications may be made therein without departing from the scope and intent of the appended claims.

1. A method for associating title keys with binding information for encrypting the title keys of a device, the method comprising:
grouping title keys for processing;
introducing associated meta-data describing content;
partitioning title keys based on meta-data associated with each content item;
establishing a prioritization between partitions;
re-encrypting title keys with current binding information based on partition priority; and
tracking said title keys to ensure they are re-encrypted.

2. The method of claim 1 wherein elements of the meta-data are based upon usage patterns of content established over a defined period of time.

3. The method of claim 2 wherein the usage pattern is based on most frequently played content.

4. The method of claim 1 wherein the meta-data is based upon user preferences.

5. The method of claim 4 wherein the user preference is based on content classification.

6. The method of claim 4 wherein the user preference is based on recently acquired content.

7. The method of claim 1 wherein the device plays one or more digital formats.

8. A system for associating title keys with binding information for encrypting the title keys of a device, the method comprising:
means for grouping title keys for processing;
means for introducing associated meta-data describing content;
means for partitioning title keys based on meta-data associated with each content item;
means for establishing a prioritization between partitions;
means for re-encrypting title keys with current binding information based on partition priority; and
means for tracking said title keys to ensure they are re-encrypted.

9. The system of claim 8 wherein elements of the meta-data are based upon usage patterns of content last accessed within a defined period of time.

10. The system of claim 9 wherein the usage pattern is based on most frequently played content.

11. The system of claim 8 wherein the meta-data is based on user preferences.

12. The system of claim 11 wherein the user preference is based on content classification.

13. The system of claim 11 wherein the user preference is based on recently acquired content.

14. The system of claim 8 wherein the device plays one or more digital formats.

15. A computer program having code recorded on a computer readable medium for fast communication with a symbol linked object based system for associating title keys with binding information for encrypting the title keys of a device, the method comprising:
means for grouping title keys for processing;
means for introducing associated meta-data describing content;
means for partitioning title keys based on meta-data associated with each content item;
means for establishing a prioritization between partitions;
means for re-encrypting title keys with current binding information based on partition priority; and
means for tracking said title keys to ensure they are re-encrypted.

16. The computer program of claim 15 wherein elements of the meta-data are based upon usage patterns of the content established over a defined period of time.

17. The computer program of claim 16 wherein the usage pattern is based on most frequently played content.

18. The computer program of claim 15 wherein the meta-data is based on user preferences.

19. The computer program of claim 18 wherein the user preference is based on recently acquired content.

20. The computer program of claim 15 wherein the device plays one or more digital formats.
